(19) United States
(12) Patent Application Publication
(10) Pub. No.: US 2015/0142609 A1
(43) Pub. Date: May 21, 2015

(54) IDENTIFYING CLASSES OF PRODUCT DESIRABILITY VIA FEATURE CORRELATIONS

(71) Applicant: Wal-Mart Stores, Inc., Bentonville, AR (US)

(72) Inventors: Nikesh Garera, Bangalore (IN); Abhishek Shrivastava, Bhilai (IN); Deeksha Sood, Bangalore (IN); Nikhil Simha, Hyderabad (IN)

(73) Assignee: Wal-Mart Stores, Inc., Bentonville, AR (US)

(21) Appl. No.: 14/081,508

(22) Filed: Nov. 15, 2013

(51) Int. Cl. G06Q 30/06; G06F 17/30

(52) U.S. Cl. CPC G06Q 30/0629; G06F 17/3053
USPC 705/26.64

(57) ABSTRACT

Some embodiments include a method of identifying desirable items in a category of items based on features. Other embodiments of related systems and methods are also disclosed.

### TECHNICAL FIELD

This disclosure relates generally to online retail of consumer merchandise, and relates more particularly to automated identification of desirable items.

### BACKGROUND

Modern consumers have a plethora of choices when selecting products to purchase. When shopping for a particular type of item, consumers often want to know which products have high-end features. As a rough generalization, high-priced items generally have high-end features, and low-priced items generally do not have high-end features. The price of an item alone, however, is not necessarily sufficient to ascertain whether the item has high-end features, as certain lower-priced items can include high-end features. Moreover, some high-priced items can have few if any high-end features and can be priced high for other reasons, such as brand reputation. Similarly, consumers often want to know which products are bargain items that have a relatively low price given the products' features.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the identification system disclosed in FIG. 3;

FIG. 2 illustrates a representative block diagram of an example of the elements included in the circuit boards inside a chassis of the computer system of FIG. 1;

FIG. 3 illustrates a block diagram of an example of a system for identifying desirable items, according to an embodiment;

FIG. 4 illustrates a flow chart for an exemplary procedure of identifying desirable items, according to another embodiment;

FIG. 5 illustrates a flow chart for an exemplary procedure of selecting one or more desirable items, according to the embodiment of FIG. 4;

FIG. 6 illustrates a flow chart for an exemplary procedure of determining a feature score, according to the embodiment of FIG. 5;

FIG. 7 illustrates a flow chart for an exemplary procedure of computing an item score, according to the embodiment of FIG. 5;

FIG. 8 illustrates a flow chart for another exemplary procedure of selecting one or more desirable items, according to the embodiment of FIG. 4;

FIG. 9 illustrates an example web page showing identification of desirable items; and

FIG. 10 illustrates a block diagram of an example of various components of the identification system, according to the embodiment of FIG. 3.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a method of identifying one or more desirable items in a category of items. The method can be implemented via execution of computer instructions configured to run at one or more processing modules and configured to be stored at one or more non-transitory memory storage modules. The method can include determining features corresponding to the items in the category. The features can be an aggregate of item features corresponding to the items in the category. The method can also include selecting the one or more desirable items from the items in the category based on the features corresponding to the items in the category. The method can also include providing identification for the one or more desirable items.

Further embodiments can include a system for identifying one or more desirable items in a category of items. The system can include one or more processing modules and one or more non-transitory memory storage modules storing computing instructions configured to run on the one or more processing modules. The computing instructions can perform the act of determining features corresponding to the items in the category. The features can be an aggregate of item features corresponding to each item. The computing instructions can also perform the act of selecting the one or more desirable items from the items in the category based on the features corresponding to the items in the category. The computing instructions can also perform the act of providing identification for the one or more desirable items.

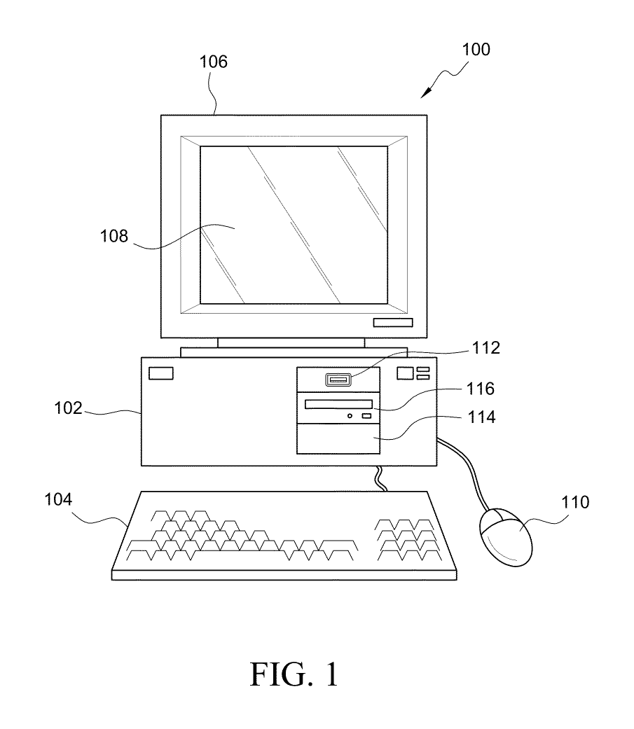

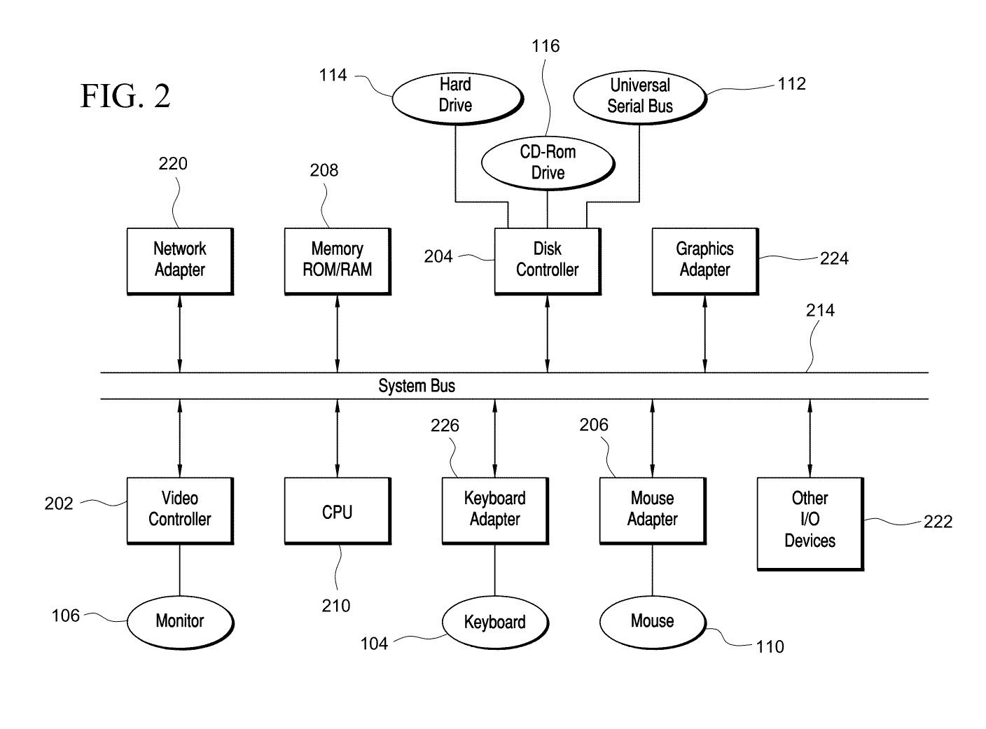

Turning to the drawings, FIG. 1 illustrates an exemplary embodiment of a computer system 100, all of which or a portion of which can be suitable for implementing the techniques described below. As an example, a different or separate one of a chassis 102 (and its internal components) can be suitable for implementing the techniques described below. Furthermore, one or more elements of computer system 100 (e.g., a refreshing monitor 106, a keyboard 104, and/or a mouse 110, etc.) can also be appropriate for implementing the techniques described below. Computer system 100 comprises chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 comprises both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can comprise microcode such as a Basic Input-Output System (BIOS). In some examples, the one or more memory storage units of the various embodiments disclosed herein can comprise memory storage unit 208, a USB-equipped electronic device, such as, an external memory storage unit (not shown) coupled to universal serial bus (USB) port 112 (FIGS. 1-2), hard drive 114 (FIGS. 1-2), and/or CD-ROM or DVD drive 116 (FIGS. 1-2). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 and the circuit boards inside chassis 102 (FIG. 1) are not discussed herein.

When computer system 100 in FIG. 1 is running, program instructions stored on a USB-equipped electronic device connected to USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out at least part of the techniques described below.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smart phone. In certain additional embodiments, computer system 100 may comprise an embedded system.

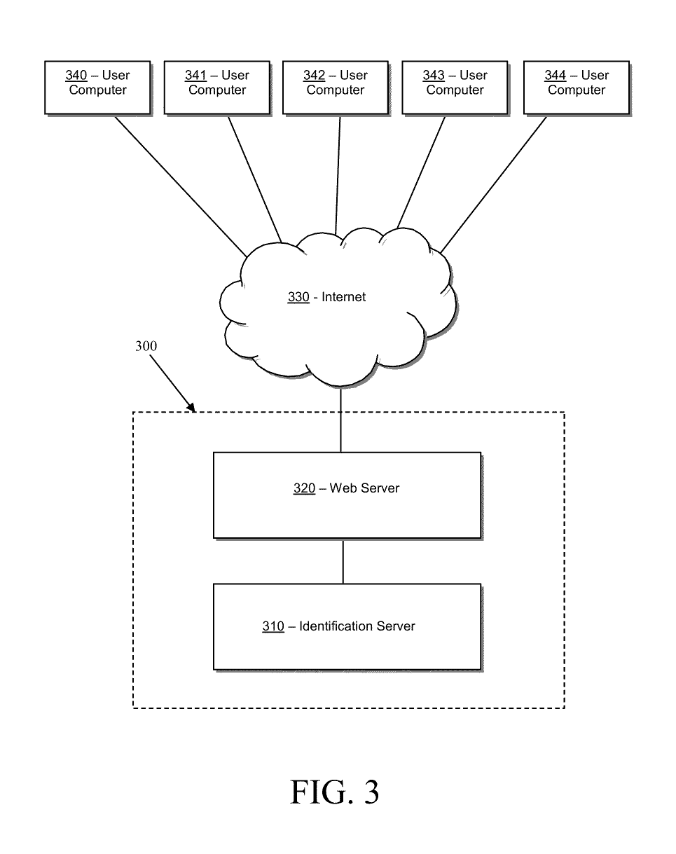

Turning ahead in the drawings, FIG. 3 illustrates a block diagram of a system 300 that can be employed for identifying desirable product based on features, according to an embodiment. System 300 is merely exemplary and embodiments of the system are not limited to the embodiments presented herein. The system can be employed in many different embodiments or examples not specifically depicted or described herein. In some embodiments, certain elements or modules of system 300 can perform various procedures, processes, and/or activities. In other embodiments, the procedures, processes, and/or activities can be performed by other suitable elements or modules of system 300. In some embodiments, system 300 can include an identification server 310 and/or a web server 320. Web server 320 and/or identification server 310 can be each be a computer system, such as computer system 100 (FIG. 1), as described above, and can each be a single computer, a single server, or a cluster or collection of computers or servers, or a cloud of computers or servers. Additional details regarding identification server 310 and web server 320 are described below.

In some embodiments, web server 320 can be in data communication through Internet 330 with user computers (e.g., 340, 341, 342, 342, 344). In certain embodiments, user computers 340-344 can be desktop computers, laptop computers, smart phones, tablet devices, and/or other endpoint devices. Web server 320 can host one or more websites. For example, web server 320 can host an eCommerce web site that allows users to browse and/or search for items, to add items to an electronic shopping cart, and/or to purchase items, in addition to other suitable activities. In various embodiments, each item sold thorough the website can be categorized in one or more categories. Accordingly, each category can include a group of items. In a number of embodiments, web server 320 can allow a user to browse items sold through the website by category. In many embodiments, a user can select the category from a list of categories, or can search on the category by search terms related to the category or items in the category. For example, a user can search for cell phones and can browse through all the cell phones that can be purchased through the web site.

In several embodiments, each item sold through the website can have a number of item features. The item features can be attributes of the item. For example, the item features can be the attributes and/or specifications of the item that were added as part of the product information at the time the item is added to the online database of products to the sold by the website. As a non-limiting example, a certain model of cell phone can be added to the online database under the category of “cell phones,” and attributes and specifications of the cell phone model can be added as item features. For example, the cell phone model can include attributes such as touchscreen, full keyboard, SMS, Email, Instant Messaging, digital camera, GPS receiver, GLONASS receiver, digital TV tuner, voice recorder, digital player, Wi-Fi hotspot, MicroUSB connector, headphone jack, MicroSD slot, and so forth. Each of these attributes can be added as an item feature for that particular cell phone model. Other models of cell phones can have the same and/or additional item features. In some embodiments, all of the attributes and specifications of an item can be added as item features for the item. In some embodiments, each item and its associated item features are stored in a database.

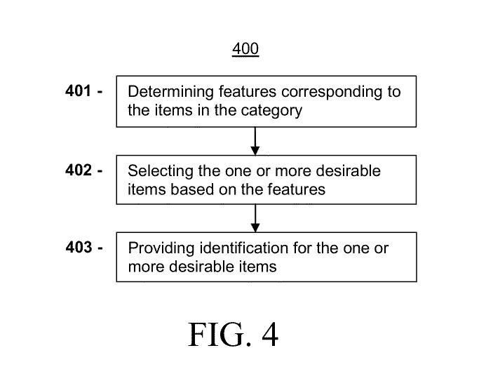

Turning ahead in the drawings, FIG. 4 illustrates a flow chart for a method 400 of identifying desirable items in a category of items, according to an embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped. In some embodiments, method 400 can be implemented by identification server 310 (FIG. 3) and/or web server 320 (FIG. 3).

Referring to FIG. 4, in some embodiments method 400 can include block 401 of determining features corresponding to the items in the category. In many embodiments, the features can be an aggregate of item features corresponding to the items in the category. Although in some embodiments there can be thousands or even millions of items in the entire online database, with each item having several item features, a particular category can have a lesser number of items. As a simple example for purposes of illustration, a category can include three items, and the first item in a particular category can have features F₁, F₂, and F₃; the second item in the category can have features F₁, F₃, F₄, and F₅; and the third item in the category can have features, F₁, F₂, F₅, and F₆, where Fₓ represents a different feature for each value of x. In this example, some of the items have overlapping item features. Specifically, for example, item feature F₁ is an item feature for each of the items, and item feature F₂ is an item feature for the first and third items. The features in the category would be each of the item features corresponding to the items in the category, which in this example would be F₁, F₂, F₃, F₄, F₅, and F₆. The features in the category can be a subset of all the item features corresponding to all the items in the entire catalog.

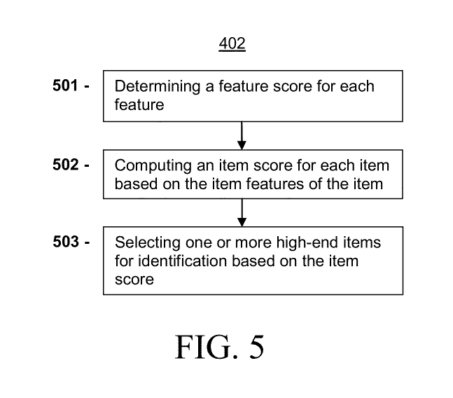

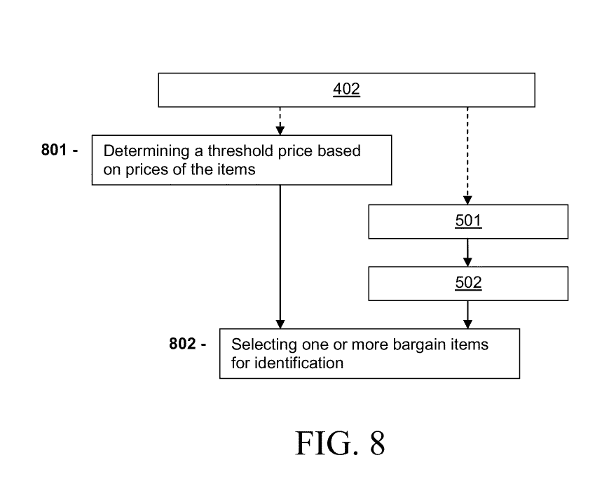

In a number of embodiments, method 400 can include block 402 of selecting one or more desirable items from the items in the category based on the features corresponding to the items in the category. Block 402 can include various embodiments in which desirable items are selected based at least in part on the features determined in block 401. In many embodiments, the selection is implemented using a method that takes into account other features in the category in addition to the item features of the item being considered for selection. In some embodiments, the selection is implemented using a method that takes into account each and every feature in the category of items. For example, block 402 of selecting one or more desirable items can be implemented as shown in FIG. 5 and/or FIG. 8, and described below.

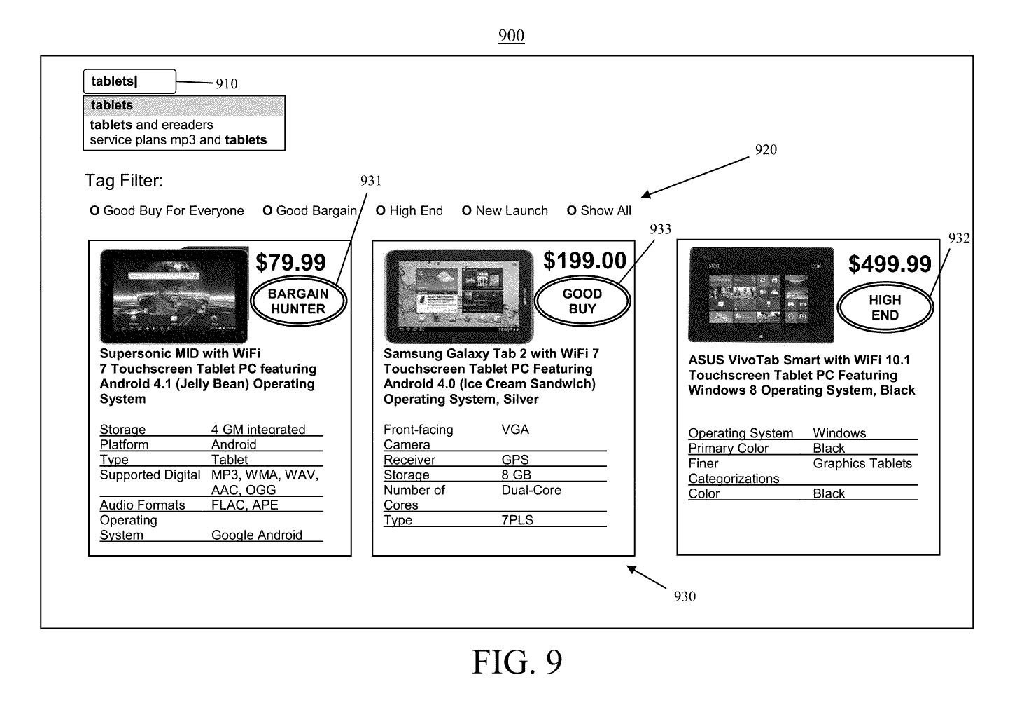

In many embodiments, method 400 can include block 403 of providing identification for one or more desirable items. The identification can be for the one or more desirable items selected in block 402. In a number of embodiments, the one or more desirable items can be identified to users through web server 320. In some embodiments, identification can be through a label, badge, or other visual indicator associated with an item on a webpage, which can indicate that the item is desirable. For example, high-end and/or bargain items that are selected in block 402 can be labeled as such on a webpage that lists the item for sale, for instance, as shown in FIG. 9 and described below, which can advantageously assist users in determining which items are high-end and/or a good bargain. Block 403 of providing identification for one or more desirable items can include providing identification for one or more high-end items and/or providing identification for one or more bargain items.

Turning ahead in the drawings, FIG. 5 illustrates a flow chart for an embodiment of block 402 of selecting one or more desirable items from the items in the category based on the features corresponding to the items in the category. Block 402 is merely exemplary and is not limited to the embodiments presented herein. Block 402 can be employed in many different embodiments or examples not specifically depicted or described herein. In some embodiments, the procedures, the processes, and/or the activities of block 402 can be performed in the order presented. In other embodiments, the procedures, the processes, and/or the activities of block 402 can be performed in any suitable order. In still other embodiments, one or more of the procedures, the processes, and/or the activities of block 402 can be combined or skipped.

In the embodiment shown in FIG. 5, block 402 can be used for selecting high-end items. Although an item may not be high-priced, it can have one or many high-end features. Such high-end features can make the item desirable to consumers, and an accurate selection of high-end items can advantageously assist consumers in choosing desirable products to purchase. Accurate selection of desirable items can beneficially increase product sales.

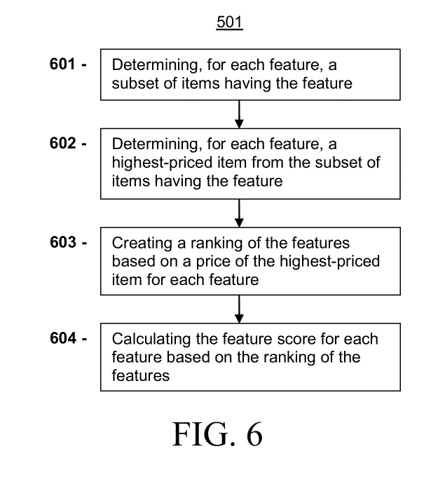

Referring to FIG. 5, in some embodiments block 402 can include block 501 of determining a feature score for each feature corresponding to the items in the category. Block 501 can include various embodiments in which a feature score is assigned to each feature. For example, block 501 of determining a feature score for each feature can be implemented as shown in FIG. 6 and described below.

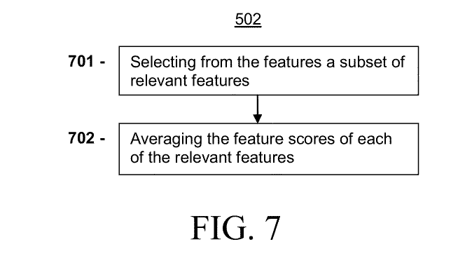

In many embodiments, block 402 in FIG. 5 can include block 502 of computing an item score for each item in the category based on the feature scores corresponding to the item. Block 502 can include various embodiments in which an item score is assigned to each item. For example, block 502 of determining a feature score for each feature can be implemented as shown in FIG. 7 and described below.

In a number of embodiments, block 402 in FIG. 5 can include block 503 of selecting one or more high-end items for identification from the items in the category based on the item score of each of the one or more high-end items. Block 503 can include various embodiments in which high-end items are selected based on item scores of the items in the category. In some embodiments, block 503 can include selecting one or more high-end items based on the item score exceeding an item score threshold, such that the high-end items each exceed the item score threshold. In certain embodiments, the item score threshold is a predetermined value. In some embodiments, the item score threshold can be different for different categories of items. In certain embodiments, the item scores are normalized between 0 and 1, and the item score threshold can be a value between 0 and 1. For example, the item score threshold can be 0.85, and items having item scores exceeding 0.85 can be selected as high-end items. In other embodiments, the item score threshold can be 0.90.

In other embodiments, the item score threshold can be predetermined based on training data. For example, for a new category of items, website users can be asked whether or not they consider certain items in that category to be high-end items. The responses from the users, together with the calculated item scores, can be stored as training data. After sufficient training data is collected for the category, identification server 310 (FIG. 3) can compute an item score threshold for the category via conventional statistical methods.

Turning ahead in the drawings, FIG. 6 illustrates a flow chart for an embodiment of block 501 of determining a feature score for each feature corresponding to the items in the category. Block 501 is merely exemplary and is not limited to the embodiments presented herein. Block 501 can be employed in many different embodiments or examples not specifically depicted or described herein. In some embodiments, the procedures, the processes, and/or the activities of block 501 can be performed in the order presented. In other embodiments, the procedures, the processes, and/or the activities of block 501 can be performed in any suitable order. In still other embodiments, one or more of the procedures, the processes, and/or the activities of block 501 can be combined or skipped.

Referring to FIG. 6, in some embodiments block 501 can include block 601 of determining, for each feature, a subset of items from the items in the category having the feature. For example, if there are a hundred items in a category, and thirty of those items have a certain feature F₁, identification server 310 (FIG. 3) can determine that those thirty items have feature F₁. This determination can be performed for each feature in the category.

In a number of embodiments, block 501 can include block 602 of determining, for each feature, a highest-priced item from the subset of items having the feature. For the example described above for block 601, identification server 310 (FIG. 3) can determine the item having the highest price from among the thirty items having feature F₁.

In many embodiments, block 501 can include block 603 of creating a ranking of the features based on a price of the highest-priced item for each feature. Block 603 can include various embodiments in which the features are ranked based on the price of the highest-priced item determined in block 602. In some embodiments, block 603 can involve creating rank buckets and categorizing each item in the category into one of the rank buckets based on a price of the item. For example, identification server 310 (FIG. 3) can create ten rank buckets, such that items having a price in the top ten percent of item prices in the category are categorized into the first rank bucket, items having a price in the second ten percent are categorized into the second rank bucket, etc. In some embodiments, the number of items in each rank bucket is approximately the same. The quantity of rank buckets can be 5, 10, 20, 100, or another suitable value. In a number of embodiments, the quantity of rank buckets can be based on the number of items in the category.

In various embodiments, block 603 can include categorizing each feature into one or more rank buckets, such that each rank bucket includes the item features corresponding to each item in the rank bucket. For example, if feature F₁ is an item feature of three items in the first rank bucket, one item in the second rank bucket, and two items in the fourth rank bucket, and no other items in the category, then feature F₁ would be categorized into the first, second, and fourth rank buckets, but not the other rank buckets.

In certain embodiments, block 501 can include block 604 of calculating the feature score for each feature based on the ranking of the features. In some embodiments block 604 can include various embodiments in which the feature score is calculated based on the feature ranking created in block 603. In certain embodiments, block 604 of calculating the feature score can include assigning a feature score for each feature based on the highest rank bucket in which the feature is categorized. Each rank bucket can have a corresponding feature score value. For the example describe above for block 603, the feature score value for the first rank bucket can be 10, the feature score for the second rank bucket can be 9, the feature score for the third rank bucket can be 8, etc., and identification server 310 (FIG. 3) can assign feature F₁ a feature score of 10 because that is the highest rank bucket in which it is categorized. Using rank buckets for determining the feature score can advantageously allow identification server 310 (FIG. 3) to assign the same feature score to multiple features.

In other embodiments, block 501 of determining a feature score for each feature can be implemented using other suitable procedures. For example, in some embodiments the feature score of a feature can be computed without ranking the features into buckets, but rather can be equal to the highest-priced item for that feature.

Turning ahead in the drawings, FIG. 7 illustrates a flow chart for an embodiment of block 502 of computing the item score for each item in the category. Block 502 is merely exemplary and is not limited to the embodiments presented herein. Block 502 can be employed in many different embodiments or examples not specifically depicted or described herein. In some embodiments, the procedures, the processes, and/or the activities of block 502 can be performed in the order presented. In other embodiments, the procedures, the processes, and/or the activities of block 502 can be performed in any suitable order. In still other embodiments, one or more of the procedures, the processes, and/or the activities of block 502 can be combined or skipped.

Referring to FIG. 7, in some embodiments block 502 can include block 701 of selecting from the features a subset of relevant features that are categorized in fewer rank buckets than a rank bucket threshold. For example, in certain features can be fairly ubiquitous as item features of items in the category. For instance, for a laptop computer category, nearly all of the laptop computer items in the category might have an item feature representing USB connectivity. As such, the USB connectivity feature would be categorized into nearly all, if not all, of the rank buckets. Because of its ubiquity, the USB connectivity feature can be largely irrelevant in determining whether items in the laptop computer category have high-end features. To filter out such ubiquitous features, identification server 310 (FIG. 3) can select relevant features that are categorized in fewer rank buckets than a predetermined rank bucket threshold. For example, if the number of rank buckets is ten, the rank bucket threshold could be set to 8, such that features appearing in 8 or more rank buckets would be filtered out, and identification server 310 (FIG. 3) would select as relevant features those features being categorized into 7 or fewer rank buckets. In various embodiments, the rank bucket threshold can be set to a number between 50 and 100% of the total number of rank buckets. In various embodiments, the initial population of item features for each item can be such that even after filtering the ubiquitous features, the number of relevant features in one or more categories can be greater than 10. In other embodiments, in one or more categories the number of relevant features can be greater than 20 or, in some cases, greater than 50.

In many embodiments, block 502 can include step 702 of computing the item score for each item in the category by averaging the feature scores of each of the relevant features corresponding to the item features of the item. For example, a particular item might have eight item features, and five of the features corresponding to those item features might have been selected as relevant features in block 701. If the five relevant features have feature scores of 10, 8, 8, 7, and 4, identification server 310 (FIG. 3) can average those feature scores to compute an item score of 7.4 for the item. In some embodiments, after item scores have been computed for each item in the category, the item scores can be normalized using conventional statistical methods. In other embodiments of method 502, identification server 310 (FIG. 3) can compute item scores for each item in the category by using other techniques. For example, the item scores can be calculated by averaging the feature scores of all item features corresponding to the item, without filtering the relevant features.

Turning ahead in the drawings, FIG. 8 illustrates a flow chart for other embodiments of block 402 of selecting one or more desirable items from the items in the category based on the features corresponding to the items in the category. Block 402 is merely exemplary and is not limited to the embodiments presented herein. Block 402 can be employed in many different embodiments or examples not specifically depicted or described herein. In some embodiments, the procedures, the processes, and/or the activities of block 402 can be performed in the order presented. In other embodiments, the procedures, the processes, and/or the activities of block 402 can be performed in any suitable order. In still other embodiments, one or more of the procedures, the processes, and/or the activities of block 402 can be combined or skipped.

In the embodiments shown in FIG. 8, block 402 can be used for selecting bargain items. An item may have a relatively low price given the item's features. When an item is priced less than a consumer might expect given the item's features, a consumer could consider the item to be a good bargain. Such bargain items can be desirable to consumers, and accurate selection of bargain items can advantageously assist consumers in choosing desirable products to purchase.

Referring to FIG. 8, in some embodiments block 402 can include block 801 of determining a threshold price based on prices of the items in the category. Block 801 can include various embodiments in which a threshold price is determined based on item prices. In certain embodiments, block 801 can include determining the threshold price such that the threshold price is equal to approximately half of an average price of all items in the category. In other embodiments, block 801 can include determining the threshold price such that the price is equal to approximately half of a median price of all items in the category. In other embodiments, the threshold price can be determined such that the price is a suitable percentage of the mean price or median price of all items in the category. For example, in certain embodiments, the threshold price can be a percentage of the mean price or median price between 20% and 90%.

In some embodiments, block 402 can include block 802 of selecting one or more bargain items for identification from the items in the category. In a number of embodiments block 802 can include selecting the bargain items such that for each of the bargain items, a quantity of the item features corresponding to the item exceeds a feature threshold percentage of a quantity of the features in the category, and a price of the item is less than a threshold price, e.g., the threshold price determined in block 801. In certain embodiments, the feature threshold percentage can be approximately 50%. In other embodiments, the feature threshold percentage can be another suitable percentage, such as between 40% and 80%. For example, in embodiments in which the threshold price is determined to be half of an average price of all items in the category, and in which a feature threshold percentage is 50%, the items selected as bargain items would be those items having items features that correspond to more than half of the features in the category, and having a price less than half of the average price of all items in the category. Such items can have a relatively rich set of features and can be priced relatively low for items in the category, which can indicate that the item is a good bargain.

In other embodiments, instead of including block 801, block 402 can include blocks 501 and 502. As described above, block 501 can be for determining a feature score for each feature corresponding to the items in the category, as described above, and, block 502 can be for computing an item score for each item in the category based on the feature scores (e.g., as determined in block 501) corresponding to the item features of the item, as described above. In certain embodiments, block 802 of selecting one or more bargain items for identification from the items in the category can include selecting the bargain items such that, for each of the bargain items, a price of the item is less than a price threshold percentage of a preliminary estimate of the price based on the item score of the item. For example, after computing the item score for each item, identification server 310 (FIG. 3) can determine a preliminary estimate for the price of each item based on the item scores of all the items. The preliminary estimate can be determined using conventional statistical estimation methods, such as, for example, linear or polynomial regression. If the actual price of the item is lower than the preliminary estimate of the price of the item by a certain price threshold percentage, then identification server (FIG. 3) can select that item as a bargain item. In certain embodiments, the price threshold percentage is 60%. In other embodiments, the price threshold percentage can be a suitable percentage in the range of 30% to 90%. Items selected using these embodiments can advantageously be selected because the price of the item is significantly less than would be expected given the item features of the item. Consumers can view such items as being good bargains and desirable to purchase, given the relatively low price of the item.

In some embodiments, selection using the preliminary estimate of the price is performed only when the number of features in the category of items is greater than or equal to a predetermined number, e.g., 20 features. Imposing a requirement for a minimum number of features can beneficially ensure that the preliminary estimate of the price is a statistically meaningful estimate. In other embodiments, selection using the preliminary estimate of the price is performed only when the number of items in the category of items is greater than or equal to a predetermined number, e.g., 20 items. Imposing a requirement for a minimum number of items can ensure that the preliminary estimate of the price can beneficially ensure that the preliminary estimate of the price is a statistically meaningful estimate. In still further embodiments, selection using the preliminary estimate of the price is performed only when the number of features in the category of items and the number of items in the category both each exceed predetermined numbers.

Turning ahead in the drawings, FIG. 9 illustrates an example web page 900 showing identification of desirable items that have been selected, for example, in accordance with embodiments described herein. Web page 900 is merely exemplary, and embodiments for providing identification of desirable items can be employed in many different embodiments or examples not specifically depicted or described herein. In some embodiments, web server 320 (FIG. 3) can provide a web page to user computers (e.g., 340-344 (FIG. 3)), which can allow a user to select a category of products. For example, web page 900 can include a category selection field 910. Web server 320 (FIG. 3) can display items in the category. In some embodiments, web page 900 can include item displays 930, which can display information about the items in the category. For example, if the user selects “tablets” in category selection field 910, item displays 930 in web page 900 can all be for tablets, such as the SuperSonic MID tablet, the Samsung Galaxy Tab 2, etc. In some embodiments, item displays 930 can include item name, price, description, list of item features, and/or other suitable information about the items. In a number of embodiments, web page 900 can provide identification of desirable items, for example, desirable items selected according to embodiments described above. In some embodiments, as shown in FIG. 9, web page 900 can include labels or “badges,” such as “bargain hunter” badge 931, which can indicate which items were selected as being bargain items (e.g., selected as shown in FIG. 8, described above). As another example, web page 900 can include a “high end” badge 932, which can be placed near or as part of item displays 930 for items selected as being high-end items (e.g., selected as shown in FIG. 5, described above). In certain embodiments, web page 900 can include one or more other badges (e.g., 933), which can be for items selected based on features and/or for items selected based on other criteria, such as top sellers, new items, etc. In some embodiments, an item can be selected as having none, one, or more than one badges. In many embodiments, web page 900 can allow a user to filter the items based on the badges. For example, web page 900 can include badge selection bar 920, which can allow a user to filter the items and for web page 900 to only display those items that were selected as desirable and identified with a badge, for example, those items with the “high-end” badge.

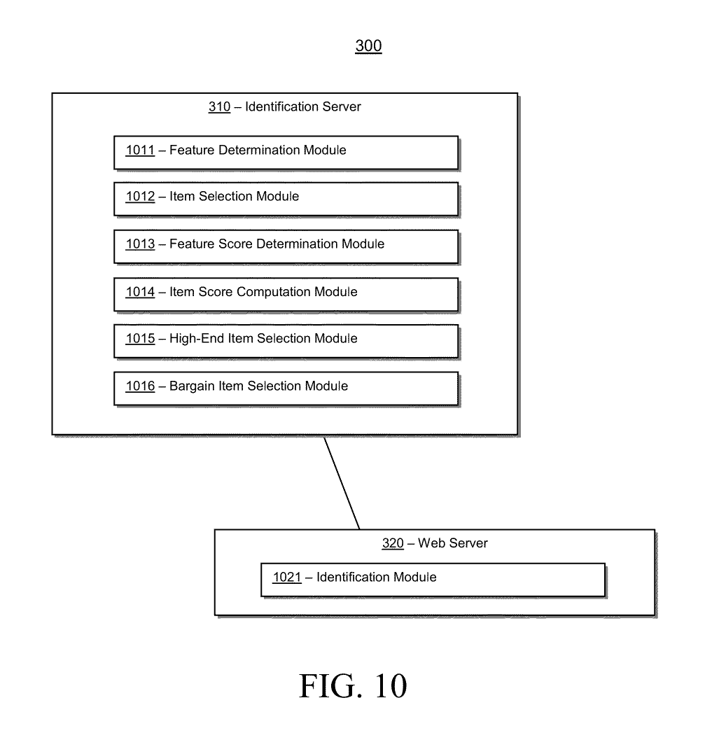

Turning ahead in the drawings, FIG. 10 illustrates a block diagram of system 300, according to the embodiment shown in FIG. 3. Identification server 310 and web server 320 are merely exemplary and are not limited to the embodiments presented herein. Identification server 310 and web server 320 can be employed in many different embodiments or examples not specifically depicted or described herein. In some embodiments, certain elements or modules of identification server 310 and/or web server 320 can perform various procedures, processes, and/or acts. In other embodiments, the procedures, processes, and/or acts can be performed by other suitable elements or modules.

In a number of embodiments, identification server 310 can include a feature determination module 1011. In certain embodiments, feature determination module 1011 can perform block 401 (FIG. 4) of determining features corresponding to items in the category. In some embodiments, identification server 310 can include an item selection module 1012. In certain embodiments, item selection module 1012 can perform block 402 (FIG. 4) of selecting one or more desirable items based on the features. In various embodiments, identification server 310 can include a feature score determination module 1013. In certain embodiments, feature score determination module 1013 can perform block 501 (FIG. 5) of determining a feature score for each feature. In a number of embodiments, feature score determination module 1013 can perform one or more of blocks 601-604 (FIG. 6).

In many embodiments, identification server 310 can include an item score computation module 1014. In certain embodiments, item score computation module 1014 can perform block 502 (FIG. 5) of computing an item score for each item based on the item features of the item. In a number of embodiments, item score computation module 1014 can perform one or more of blocks 701-702 (FIG. 7). In various embodiments, identification server 310 can include a high-end item selection module 1015. In certain embodiments, high-end item selection module 1015 can perform block 503 (FIG. 5) of selection one or more high-end items for identification based on the item score. In several embodiments, identification server 310 can include a bargain item selection module 1016. In certain embodiments, bargain item selection module 1016 can perform block 801 (FIG. 8) of determining a threshold price based on prices of the items and/or block 802 (FIG. 8) of selecting one or more bargain items for identification.

In some embodiments, web server 320 can include identification module 1021. In certain embodiments, identification module 1021 can perform block 403 (FIG. 4) of providing identification for one or more desirable items.

Although identifying desirable items in a category of items based on features has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-10 may be modified, and that the foregoing discussion of certain of these embodiments does not necessarily represent a complete description of all possible embodiments. For example, one or more of the procedures, processes, or activities of FIGS. 4-8 may be include different procedures, processes, and/or activities and be performed by many different modules, in many different orders. As another example, the modules within identification server 310 and web server 320 in FIG. 10 can be interchanged or otherwise modified.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A method of identifying one or more desirable items in a category of items, the method being implemented via execution of computer instructions configured to run at one or more processing modules and configured to be stored at one or more non-transitory memory storage modules, the method comprising:
determining features corresponding to the items in the category, the features being an aggregate of item features corresponding to the items in the category;
selecting the one or more desirable items from the items in the category based on the features corresponding to the items in the category; and
providing identification for the one or more desirable items.

2) The method of claim 1, wherein:
selecting the one or more desirable items comprises:
determining a feature score for each feature corresponding to the items in the category;
computing an item score for each item in the category based on the feature scores corresponding to the item features of the item; and
selecting one or more high-end items for identification from the items in the category based on the item score of each of the one or more high-end items; and
providing identification for the one or more desirable items comprises providing identification for the one or more high-end items.

3) The method of claim 2, wherein computing the item score for each item in the category comprises computing the item score for each item by averaging the feature scores of all item features corresponding to the item.

4) The method of claim 2, wherein determining the feature score for each feature comprises:
determining, for each feature, a subset of items from the items in the category having the feature;
determining, for each feature, a highest-priced item from the subset of items having the feature;
creating a ranking of the features based on a price of the highest-priced item for each feature; and
calculating the feature score for each feature based on the ranking of the features.

5) The method of claim 4, wherein:
creating the ranking of the features comprises:
creating rank buckets and categorizing each item in the category into one of the rank buckets based on a price of the item; and
categorizing each feature into one or more rank buckets, such that each rank bucket includes the item features corresponding to each item in the rank bucket; and
calculating the feature score for each feature comprises assigning a feature score for each feature based on a highest rank bucket in which the feature is categorized.

6) The method of claim 5, wherein a quantity of the items in each rank bucket is approximately the same, and a quantity of the rank buckets is 10.

7) The method of claim 5, wherein computing the item score for each item in the category comprises:
selecting from the features a subset of relevant features that are categorized in fewer rank buckets than a rank bucket threshold; and
computing the item score for each item in the category by averaging the feature scores of each of the relevant features corresponding to the item features of the item.

8) The method of claim 7, wherein a quantity of the subset of relevant features is greater than or equal to 10.

9) The method of claim 2, wherein selecting the one or more high-end items for identification comprises selecting the one or more high-end items based on the item score for each of the one or more high-end items exceeding an item score threshold.

10) The method of claim 9 wherein selecting the one or more high-end items for identification further comprises:
predetermining the item score threshold based on training data.

11) The method of claim 2, wherein:
determining the feature score for each feature comprises:
determining, for each feature, a subset of items from the items in the category having the feature;
determining, for each feature, a highest-priced item from the subset of items having the feature;
creating a ranking of the features based on a price of the highest-priced item for each feature comprising:
creating rank buckets and categorizing each item in the category into one of the rank buckets based on a price of the item, wherein a quantity of the rank buckets is 10, and a quantity of the items in each rank bucket is approximately the same; and
categorizing each feature into one or more rank buckets, such that each rank bucket includes the item features corresponding to each item in the rank bucket; and
calculating the feature score for each feature based on a highest rank bucket in which the feature is categorized;
computing the item score for each item in the category comprises:
selecting from the features a subset of relevant features that are categorized in fewer rank buckets than a rank bucket threshold, wherein a quantity of the subset of relevant features is greater than or equal to 10; and
computing the item score for each item in the category by averaging the feature scores of each of the relevant features corresponding to the item features of the item; and
selecting the one or more high-end items for identification comprises selecting the one or more high-end items based on the item score for each of the one or more high-end items exceeding an item score threshold.

12) The method of claim 1, wherein:
selecting the one or more desirable items comprises:
determining a threshold price based on prices of the items in the category; and
selecting one or more bargain items for identification from the items in the category such that, for each of the one or more bargain items, (a) a quantity of the item features corresponding to the item exceeds a feature threshold percentage of a quantity of the features in the category, and (b) a price of the item is less than a threshold price; and
providing identification for the one or more desirable items comprises providing identification for the one or more bargain items.

13) The method of claim 12, wherein determining the threshold price comprises determining the threshold price such that the threshold price is equal to approximately half of an average price of all items in the category.

14) The method of claim 12, wherein the feature threshold percentage is approximately 50%.

15) The method of claim 1, wherein:
selecting the one or more desirable items comprises:
determining a feature score for each feature corresponding to the items in the category;
computing an item score for each item in the category based on the feature scores corresponding to the item features of the item; and
selecting one or more bargain items for identification from the items in the category such that, for each of the one or more bargain items, a price of the item is less than a price threshold percentage of a preliminary estimate of the price based on the item score of the item; and
providing identification for the one or more desirable items comprises providing identification for the one or more bargain items.

16) The method of claim 15, wherein a quantity of the features in the category of the items is greater than or equal to 20.

17) A system for identifying one or more desirable items in a category of items, the system comprising:
one or more processing modules; and
one or more non-transitory memory storage modules storing computing instructions configured to run on the one or more processing modules and perform the acts of:
determining features corresponding to the items in the category, the features being an aggregate of item features corresponding to each item;
selecting the one or more desirable items from the items in the category based on the features corresponding to the items in the category; and
providing identification for the one or more desirable items.

18) The system of claim 17, wherein the computing instructions are further configured such that:
selecting the one or more desirable items comprises:
determining a feature score for each feature corresponding to the items in the category;
computing an item score for each item in the category based on the feature scores corresponding to the item features of the item; and
selecting one or more high-end items for identification from the items in the category based on the item score of each of the one or more high-end items; and
providing identification for the one or more desirable items comprises providing identification for the one or more high-end items.

19) The system of claim 17, wherein the computing instructions are further configured such that:
selecting the one or more desirable items comprises:
determining a threshold price based on prices of the items in the category; and
selecting one or more bargain items for identification from the items in the category such that, for each of the one or more bargain items, (a) a quantity of the item features corresponding to the item exceeds a feature threshold percentage of a quantity of the features in the category, and (b) a price of the item is less than a threshold price; and
providing identification for the one or more desirable items comprises providing identification for the one or more bargain items.

20) The system of claim 17, wherein the computing instructions are further configured such that:
selecting the one or more desirable items comprises:
determining a feature score for each feature corresponding to the items in the category;
computing an item score for each item in the category based on the feature scores corresponding to the item features of the item; and
selecting one or more bargain items for identification from the items in the category such that, for each of the one or more bargain items, a price of the item is less than a price threshold percentage of an expected price for the item score of the item; and
providing identification for the one or more desirable items comprises providing identification for the one or more bargain items.
